(19) United States
(12) Patent Application Publication
(10) Pub. No.: US 2005/0178069 A1
(43) Pub. Date: Aug. 18, 2005

(54) Door weather strip

(76) Inventors: Norimasa Iwasa, Aichi-ken (JP); Masahiro Nozaki, Aichi-ken (JP)

Correspondence Address: POSZ LAW GROUP, PLC, 12040 SOUTH LAKES DRIVE, SUITE 101, RESTON, VA, 20191, US

(21) Appl. No.: 11/043,430

(22) Filed: Jan. 27, 2005

(30) Foreign Application Priority Data
Jan. 28, 2004 (JP) P2004-019133
Jun. 25, 2004 (JP) P2004-187595

(51) Int. Cl. E06B 7/16

(52) U.S. Cl. 49/498.1

(57) ABSTRACT

In a molded part of a door weather strip which is disposed in corner portion of a vehicle door, sealing forms are changed along a longitudinal direction thereof such that a sealing form in a vertical side portion of the door is made up of a compression type and a sealing form in an upper side portion of the door is made up of a bending type. A projection is projected on an interior wall surface of a location of a hollow seal portion of the molded part which corresponds to a seal surface which is brought into contact with a vehicle body, and the thickness of the location which corresponds to the seal surface is made thicker than the thickness of another location of the hollow seal portion.

### BACKGROUND OF THE INVENTION

1. Field of the Invention

The present invention relates to a door weather strip attached to a door of a vehicle.

2. Description of the Related Art

Conventionally, a door weather strip is attached to a peripheral portion of a door of a vehicle such as an automobile. The door weather strip includes extruded parts which are formed through an extrusion process for disposition to a vertical side portion and a horizontal side portion of the door and a molded part which is molded through a molding process for disposition to a corner portion of the door, and taken as an example is a door weather strip attached to a rear door pivoted on a center pillar of an automobile.

As shown in FIGS. 9, 10, a door weather strip 81 attached to a rear door 80 which is pivoted on a center pillar of an automobile includes a base portion 82 held on a peripheral portion of the rear door 80, a hollow seal portion 83 which extends from the base portion 82 and a lip portion 84 which extends from a proximal end portion of the hollow seal portion 83. Then, when the door is closed, the hollow seal portion 83 and the lip portion 84 are brought into contact or press contact with a peripheral portion of an opening in an automobile body 85 to thereby create a seal between the automobile body 85 and the rear door 80.

However, in the door weather strip 81, a so-called compression type sealing form is used as a sealing form for a portion which is attached to a vertical side portion on a pivoted side of the door, and at this portion, substantially a top portion of the hollow seal portion 83 is brought into press contact with the automobile body 85 in such a manner as to be press collapsed (refer to FIG. 9). On the other hand, a so-called bending type sealing form is used as a sealing form for a portion which is attached to an upper side portion of the rear door 80, and at this portion, the hollow seal portion 83 is brought into contact with a roof portion of the automobile body 85 in such a manner as to fall down (refer to FIG. 10). Due to this, the hollow seal portion 83 is twisted at the molded part, which corresponds to a corner portion where the roof portion intersects with the center pillar, in particular, at a portion where the sealing forms are changed over, and creases are formed in a seal surface of the hollow seal portion so twisted, resulting in a risk that the sealing properties are reduced.

To cope with this problem, a door weather strip has been proposed in which the sectional shape of the seal portion is gradually changed from a vertical side portion side to a upper side portion side of the molded part so as to control the generation of creases described as above (refer to, for example, Patent Publication No. JP 3104576B).

However, since it is not possible to foresee where the creases are generated due to manufacturing tolerance or attaching tolerance of door weather strips, there may still remain in the door weather strip described in the patent publication No. 3104576 the risk that the creases are generated.

Note that a problem like this may occur not only in the weather strip attached to the pivoted door but also in weather strips attached to other types of doors. To be more specific, in the event that the length of both the extruded parts which are connected to the molded part which constitutes the corner portion becomes too long or too short due to the manufacturing tolerance or the like, there is a risk that the effect of the result of the manufacturing tolerance appears, when the door is closed, in the form of twist and/or crease in the seal portion of the molded part. For example, in the event that an extruded part which is slightly longer than a predetermined length is supplied, a residual stress remains in the molded part in a compressing direction, whereas in the event that an extruded part which is slightly shorter than the predetermined length is supplied, part of the molded part is made thinner or a residual stress remains therein in a tensioning direction, and these stresses go into action when the hollow seal portion is deformed when the door is closed, whereby there may be caused a risk that twist and creases are generated in the hollow seal portion.

### SUMMARY OF THE INVENTION

The invention was made with a view to solving the problem, and an object thereof is to provide a door weather strip which can control the generation of twist and creases in the corner portion thereof so as to increase the sealing properties thereof.

Hereinafter, various aspects of the invention which are suitable to achieve the object are itemized for description. Note that a function and advantage inherent in the corresponding aspect of the invention will be added as required.

Aspect 1: A door weather strip comprising a hollow seal portion attached to a peripheral portion of a door of a vehicle and adapted to be brought into elastic contact or press contact with a contact portion of a vehicle body when the door is closed to thereby create a seal between the vehicle body and the door, the weather strip comprising:

a first extruded part disposed along a predetermined vertical side portion of the door;

a second extruded part disposed along a predetermined horizontal side portion of the door; and

a molded part continuously molded to the first extruded part and the second extruded part for connection thereto and disposed to correspond a corner portion where the vertical side portion and the horizontal side portion of the door meet each other and the vicinity thereof, wherein
the thickness of at least part of a location of the hollow seal portion of the molded part which correspond to a seal surface which is brought into contact or press contact with the vehicle body is made thicker than the thickness of other locations of the hollow seal portion.

According to foregoing, by making the thickness of at least part of the location of the hollow seal portion of the molded part which correspond to the seal surface thicker than the thickness of other locations of the hollow seal portion, the rigidity of the location which corresponds to the seal surface and the vicinity thereof is increased. Consequently, the generation of twist and creases in the hollow seal portion at the corner portion of the door weather strip is suppressed when the door is closed, whereby the sealing properties are attempted to be increased. Furthermore, according to the invention, since the generation of twist and creases is suppressed by increasing the rigidity of the location which corresponds to the seal surface, it is possible to deal with a deviation of the position where the twist and creases are generated which results from the manufacturing tolerance and attaching tolerance of the weather strip, whereby the sealing properties can be attempted to be increased in a more ensured fashion. As a result, the dispersion of the length of the extruded part resulting from the manufacturing tolerance and the like can be allowed. In addition, since only the location which corresponds to the seal surface or part thereof is made thicker, the increase in rigidity of the entirety of the hollow seal portion is suppressed and hence, the increase in the door closing force can be suppressed. Additionally, in the molded part, in addition to the increase in thickness of the location which corresponds to the seal surface or part thereof, only the sectional shape of the hollow seal portion is gradually changed, and therefore, since the configuration of the molded part least needs to be made different from the configuration of the extruded parts, the occurrence of drawbacks that the production process is made complicated and the production costs are increased can be suppressed. However, there will be no problem even in the event that the sectional shape of the location whose thickness is increased (the thicker portion) is gradually changed without changing the sectional shape of a main part of the hollow seal portion to a different one.

Aspect 2: A sealing form for the first extruded part and a sealing form for the second extruded part may be substantially the same sealing form.

In other words, in the molded part, a sealing form for the portion disposed along the vertical side portion of the door and a sealing form for the portion disposed along the horizontal side portion of the door are substantially the same sealing form.

Aspect 3: The sealing form may be of a compression type in which substantially a top portion of the hollow seal portion is brought into press contact with the vehicle body in such a manner as to press collapsed.

Aspect 4: The sealing form may be of a bending type in which the hollow seal portion is brought into contact or press contact with the vehicle body in such a manner as to be inclined.

Aspect 5: A door weather strip comprising a hollow seal portion attached to a peripheral portion of a door pivoted at an opening of a vehicle body and adapted to be brought into elastic contact or press contact with a contact portion of the vehicle body when the door is closed to thereby create a seal between the vehicle body and the door, the weather strip comprising:

a first extruded part disposed along a vertical side portion on a pivoted side of the door, in which the hollow seal portion is brought into contact or press contact with the vehicle body in a first sealing form;

a second extruded part disposed along a predetermined horizontal side portion of the door, in which the hollow seal portion is brought into contact or press contact with the vehicle body in a second sealing form; and

a molded part continuously molded to the first extruded part and the second extruded part for connection thereto and disposed to correspond a corner portion where the vertical side portion on the pivoted side and the horizontal side portion of the door meet each other and the vicinity thereof, in which the hollow seal portion of a portion of the molded part which is disposed along the vertical portion on the pivoted side of the door is brought into contact or press contact with the vehicle body in the first sealing form, and the hollow seal portion of a portion of the molded part which is disposed along the predetermined horizontal side portion of the door is brought into contact or press contact with the vehicle body in the second sealing form, wherein
the thickness of at least part of a location of the hollow seal portion of the molded part which correspond to a seal surface which is brought into contact or press contact with the vehicle body is made thicker than the thickness of other locations of the hollow seal portion.

According to foregoing, by making the thickness of at least part of the location of the hollow seal portion of the molded part which correspond to the seal surface thicker than the thickness of other locations of the hollow seal portion, the rigidity of the location which corresponds to the seal surface and the vicinity thereof is increased. Consequently, the generation of twist and creases in the hollow seal portion at the corner portion of the door weather strip where the sealing forms of the hollow seal portion are changer over is suppressed when the door is closed, whereby the sealing properties are attempted to be increased. Furthermore, according to the aspect of the invention, since the generation of twist and creases is suppressed by increasing the rigidity of the location which corresponds to the seal surface, it is possible to deal with a deviation of the position where the twist and creases are generated which results from the manufacturing tolerance and attaching tolerance of the weather strip, whereby the sealing properties can be attempted to be increased in a more ensured fashion. As a result, the dispersion of the length of the extruded part resulting from the manufacturing tolerance and the like can be allowed. In addition, since only the location which corresponds to the seal surface or part thereof is made thicker, the increase in rigidity of the entirety of the hollow seal portion is suppressed and hence, the increase in the door closing force can be suppressed. Additionally, in the molded part, in addition to the increase in thickness of the location which corresponds to the seal surface or part thereof, only the sectional shape of the hollow seal portion is gradually changed, and therefore, since the configuration of the molded part least needs to be made different from the configuration of the extruded parts, the occurrence of drawbacks that the production process is made complicated and the production costs are increased can be suppressed. However, there will be no problem even in the event that the sectional shape of the location whose thickness is increased (the thicker portion) is gradually changed without changing the sectional shape of a main part of the hollow seal portion to a different one.

Aspect 6: At least a projection may be provided on an interior wall surface of a location of the hollow seal portion of the molded part which corresponds to the seal surface in such a manner as to project from the interior wall surface and to have a predetermined length relative to a longitudinal direction of the molded part.

According to foregoing, since the location which corresponds to the seal surface or part thereof is made thicker by forming the projection inside the hollow seal portion, the decrease in sealing properties can be suppressed without affecting largely the seal surface on an exterior side of the hollow seal portion.

Aspect 7: The projection may be provided over substantially the whole area of the molded part in the longitudinal direction thereof.

According to foregoing, the deviation of the position where the twist and creases are generated in the longitudinal direction of the door weather strip can be allowed in a more ensured fashion, and the effect of suppressing the generation of twist and creases is increased further, whereby the sealing properties are increased further.

Aspect 8: The projection may be provided along a circumferential direction of the interior wall surface of the hollow seal portion which intersects substantially at right angles with a longitudinal direction of the hollow seal portion in a predetermined width in such a manner as to include a portion corresponding to a top portion of the hollow seal portion within a range thereof.

According to foregoing, the deviation of the position where the twist and creases are generated can be allowed which occurs in the direction which intersects substantially at right angles with the longitudinal direction of the door weather strip due to the manufacturing tolerance and attaching tolerance of the door weather strip and, furthermore, a deviation of the contact position between the hollow seal portion and the vehicle body, and the effect of suppressing the generation of twist and creases can be increased further, whereby the sealing properties are increased further.

Aspect 9: The width of the projection which extends along the circumferential direction of the interior wall surface of the hollow seal portion may be gradually changed along the longitudinal direction of the hollow seal portion of the molded part.

According to foregoing, a projection can be formed in such a manner as to correspond to the respective locations of the hollow seal portion in accordance with the range in which the respective locations of the hollow seal portion are brought into contact and difference in load applied to the respective locations of the hollow seal portion. As a result, the increase in rigidity of the entirety of the hollow seal portion is suppressed, and hence the increase in door closing force can be suppressed. Furthermore, since a wasteful portion can be omitted, such a drawback as an increase in production costs can be suppressed, as well.

Aspect 10: The projecting length of the projection from the interior wall surface of the hollow seal portion may be gradually changed in the longitudinal direction of the hollow seal portion of the molded part.

According to foregoing, a function and advantage similar to those of Aspect 8 can be provided.

Aspect 11: A door weather strip comprising a hollow seal portion attached to a peripheral portion of a door of a vehicle and adapted to be brought into elastic contact or press contact with a contact portion of a vehicle body when the door is closed to thereby create a seal between the vehicle body and the door, the weather strip comprising:

a first extruded part disposed along a predetermined vertical side portion of the door;

a second extruded part disposed along a predetermined horizontal side portion of the door; and

a molded part continuously molded to the first extruded part and the second extruded part for connection thereto and disposed to correspond a corner portion where the vertical side portion and the horizontal side portion of the door meet each other and the vicinity thereof, wherein

at least an elongated projection is provided on an interior wall surface of at least a location of the hollow seal portion of the molded part which corresponds to a seal surface which is brought into contact or press contact with the vehicle body in such a manner as to project from the interior wall surface and to have a predetermined length relative to a longitudinal direction of the molded part.

Aspect 12: A door weather strip comprising a hollow seal portion attached to a peripheral portion of a door pivoted at an opening of a vehicle body and adapted to be brought into elastic contact or press contact with a contact portion of the vehicle body when the door is closed to thereby create a seal between the vehicle body and the door, the weather strip comprising:

a first extruded part disposed along a vertical side portion on a pivoted side of the door, in which the hollow seal portion is brought into contact or press contact with the vehicle body in a first sealing form;

a second extruded part disposed along a predetermined horizontal side portion of the door, in which the hollow seal portion is brought into contact or press contact with the vehicle body in a second sealing form; and

a molded part continuously molded to the first extruded part and the second extruded part for connection thereto and disposed to correspond a corner portion where the vertical side portion on the pivoted side and the horizontal side portion of the door meet each other and the vicinity thereof, in which the hollow seal portion of a portion of the molded part which is disposed along the vertical portion on the pivoted side of the door is brought into contact or press contact with the vehicle body in the first sealing form, and the hollow seal portion of a portion of the molded part which is disposed along the predetermined horizontal side portion of the door is brought into contact or press contact with the vehicle body in the second sealing form, wherein

at least an elongated projection is provided on an interior wall surface of at least a location of the hollow seal portion of the molded part which corresponds to a seal surface which is brought into contact or press contact with the vehicle body in such a manner as to project from the interior wall surface and to have a predetermined length relative to a longitudinal direction of the molded part.

Aspect 13: The door may be a rear door which is pivoted on a center pillar of the vehicle body.

Aspect 14: The predetermined horizontal side portion of the door may be an upper side portion which corresponds to a roof side of the vehicle body.

Aspect 15: The hollow seal portion is formed of a foamed unit.

### BRIEF DESCRIPTION OF THE DRAWINGS

FIG. 1 is a side view of an automobile to which a rear door is mounted;

FIG. 2 is a partial front view showing the vicinity of a front upper corner of a door weather strip;

FIG. 3 is a sectional view taken along the line VII-VII in FIG. 2;

FIG. 4 is a sectional view taken along the line VIII-VIII in FIG. 2;

FIG. 5 is a sectional view of a door weather strip according to another embodiment;

FIG. 6 is a sectional view of a door weather strip according to a further embodiment;

FIG. 7 is a sectional view of a door weather strip according to another embodiment;

FIG. 8 is a sectional view of a door weather strip according to a further embodiment;

FIG. 9 is a sectional view of a conventional door weather strip; and

FIG. 10 is a sectional view of the conventional door weather strip.

### DETAILED DESCRIPTION OF THE PREFERRED EMBODIMENTS

An embodiment of a door weather strip which is attached to a door of a vehicle will be described below by reference to the accompanying drawings by taking as an example a door weather strip which is attached to a peripheral portion of a rear door of an automobile.

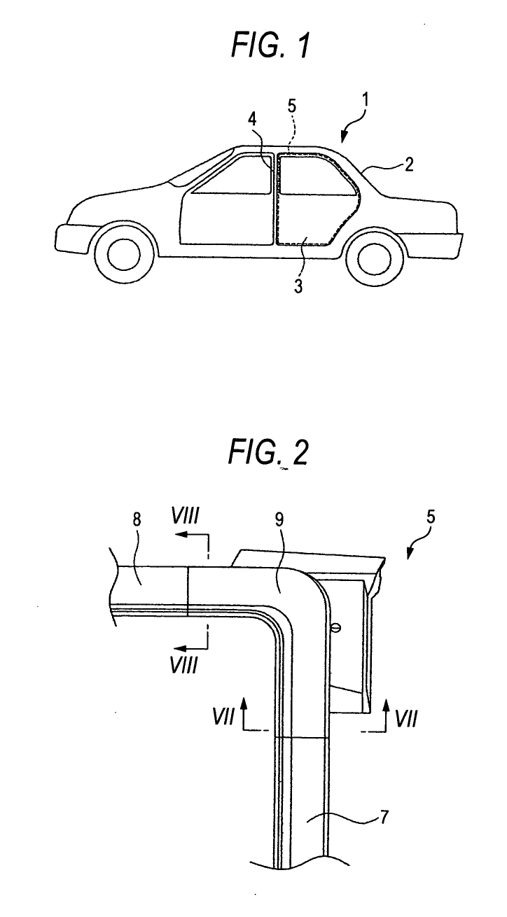

As shown in FIG. 1, a rear door 3 is mounted in an opening in a body 2 as a vehicle body of an automobile 1 as a vehicle. The rear door 3 is pivoted on a center pillar 4 side with door hinges, not shown, having pivot shafts, and a door weather strip 5 is attached continuously to the perimeter of the rear door 3.

The door weather strip 5 is formed of an EPDM (ethylene-propylene-dien copolymer) sponge and includes, as shown in FIG. 2, a first extruded part 7 which is disposed along a vertical side portion on a pivoted side of the rear door 3, a second extruded part which is disposed along an upper side portion as a horizontal side portion of the rear door 3 which corresponds to a roof portion of the body 2 and a molded part 9 which is disposed at a front upper corner portion where the vertical side portion on the pivoted side and the upper side portion of the rear door 3 intersect with each other and the vicinity of the corner portion. Note that the extruded parts 7, 8 are extruded substantially rectilinearly (in an elongated fashion) by an extrusion machine, not shown. In addition, the molded part 9 is molded continuously to the extruded parts 7, 8 so as to connect them using a predetermined mold system in such a manner that end edges of the adjacent extruded parts 7, 8 are connected together via the molded part 9.

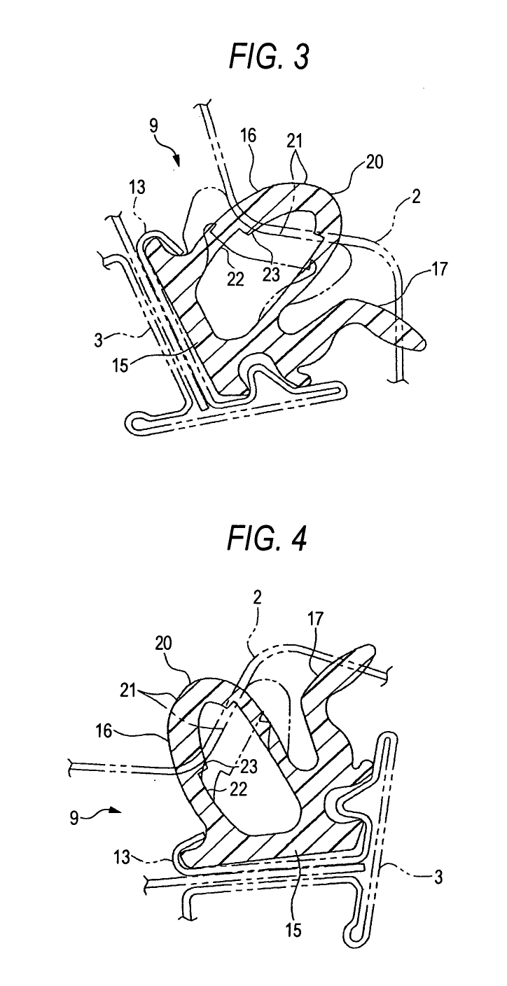

As shown in FIGS. 3, 4, the door weather strip 5 (a main part of the molded part 9) includes a base portion 15 which is attached to a door frame 13 of the rear door 3, a hollow seal portion 16 which extends from the base portion 15 and a lip portion 17 which extends from a proximal end portion of the hollow seal portion 16. Note that, while not shown, both the extruded parts 7, 8 and the molded part 9 are formed so as to have substantially similar sectional shapes. Then, when the rear door 13 is closed, the hollow seal portion 16 and the lip portion 17 are brought into elastic contact or press contact with a contact portion of the body 2 to thereby create a seal between the body 2 and the rear door 3.

A sealing form for the first extruded part 7 is of a compression type in which a substantially top portion 20 of the hollow seal portion 16 is brought into press contact with the body 2 (the center pillar 4) in such a manner as to be collapsed. This sealing form constitutes a first sealing form in the embodiment.

A sealing form for the second extruded part 8 is of a bending type in which the hollow seal portion 16 is brought into contact or press contact with the body 2 (the roof portion) in such a manner as to be inclined. This sealing form constitutes a second sealing form in the embodiment.

Consequently, in the molded part 9, which is molded continuously to the extruded parts 7, 8 so as to connect them together, the compression type sealing form is used as a sealing form for a portion which is disposed along the vertical side portion on the pivoted side of the rear door 3 or a vertical side portion, and the hollow seal portion 16 at this vertical side portion is brought into press contact with the body in such a manner as to be collapsed (refer to FIG. 3), whereas the bending type sealing form is used as a sealing form for a portion which is disposed along an upper side portion of the rear door 3 or an upper side portion, and the hollow seal portion 16 of the upper side portion is brought into contact or press contact with the body 2 in such a manner as to be inclined (refer to FIG. 4). Namely, in the molded part 9, the sealing forms are changed over at an intermediate position along the longitudinal direction thereof.

Furthermore, a projection 23 is provided on an interior wall surface 22 of a location of the hollow seal portion 16 of the molded part 9 which corresponds to a seal surface 21 which is brought into contact or press contact with the body 2 in such a manner as to project from the interior wall surface 22. The projection 23 is formed along substantially the whole area of the molded part 9 in a longitudinal direction thereof. In addition, the projection 23 is provided to extend along a circumferential direction of the interior wall surface 22 of the hollow sea portion 16 which intersects substantially at right angles with a longitudinal direction of the hollow seal portion 16 in a predetermined width in such a manner as to include a portion corresponding to the top portion 20 of the hollow seal portion 16 within a range thereof. Consequently, the thickness of the location of the molded part 9 which corresponds to the seal surface 21 is made thicker than the thickness of other portions of the hollow seal portion 16.

Since, by adopting the construction like this, the rigidity of the location which corresponds to the seal surface 21 an the vicinity thereof is increased, in the molded part where the sealing forms of the hollow seal portion 16 are changed over, the generation of twist and creases in the hollow seal portion 16 is suppressed when the rear door is closed, whereby the sealing properties can be attempted to be increased.

In the embodiment, since the generation of twist and creases is suppressed by increasing the rigidity of the location which corresponds to the seal surface 21, it is possible to deal with the deviation of the position where the twist and creases are generated due to the manufacturing tolerance and attaching tolerance of the door weather strip 5, whereby the sealing properties can be attempted to be increased in a more ensured fashion.

In addition, since the thickness of only the location which corresponds to the seal surface 21 is increased, the increase in rigidity of the entirety of the hollow seal portion 16 is suppressed, and hence, the increase in door closing force an be suppressed.

In addition, in addition to the increase in thickness of the location which corresponds to the seal surface 21, the sectional shape of the hollow seal portion 16 of the molded part 9 is gradually changed, and therefore, since the configuration of the molded part 9 least needs to be made different from the configuration of the hollow seal portion 16 of the extruded part 7, the occurrence of drawbacks that the production process is made complicated and the production costs are increased can be suppressed.

Furthermore, in the embodiment, since the projection 23 is formed along the whole area of the molded part 9 in the longitudinal direction thereof, the deviation of the position where the twist and creases are generated in the longitudinal direction of the molded part 9 can be allowed in a more ensured fashion, and the effect of suppressing the generation of twist and creases is increased further, whereby the sealing properties are increased further. Hence, the dispersion of the length of the extruded parts due to the manufacturing tolerance and the like can also be permitted.

In addition, since the projection 23 is provided along the circumferential direction of the interior wall surface 22 of the hollow seal portion 16 which intersects substantially at right angles with the longitudinal direction of the hollow seal portion 16 in a predetermined width in such a manner as to include a portion corresponding to the top portion 20 of the hollow seal portion 16 within a range thereof, the deviation of the position where the twist and creases are generated can be allowed which occurs in the direction which intersects substantially at right angles with the longitudinal direction of the door weather strip 5 due to the manufacturing tolerance and attaching tolerance of the door weather strip 5 and furthermore, a deviation of the contact position between the hollow seal portion 16 and the vehicle body 2, and the effect of suppressing the generation of twist and creases can be increased further, whereby the sealing propertied are increased further.

Note that the invention is not limited to what has been described heretofore as to the embodiment thereof and may be embodied as below for example. Of course, it goes without saying that other applications and modifications that will not be described below can also be made without departing from the spirit and scope of the invention.

(a) While, in the embodiment, the invention is embodied as the door weather strip 5 for the rear door 3, there is no limitation on the location of a door to which the door weather strip is attached, and therefore, the invention can be applied to a door weather strip for attachment to a front door.

In addition, while, in the embodiment, the sealing form is described as being changed over from the compression type to the bending type at the intermediate position along the molded part 9, the invention may be embodied as a door weather strip in which such a sealing form changeover does not occur. For example, in a weather strip in which as the sealing form, the compression type or bending type sealing form is used over the whole area of the molded part 9 in the longitudinal direction thereof, the projection 23 may be constructed so as be provided at the molded part which constitutes the corner portion. By adopting the construction, even in the event that a dispersion of the length of the extruded parts occurs due to the manufacturing tolerance and the like, the generation of twist and creases attributed to the dispersion can be suppressed, whereby the sealing properties can be attempted to be increased.

(b) While, in the embodiment, the door weather strip 5 is formed from EPDM, the door weather strip 5 may be formed from other materials such as thermoplastic olefin elastomer.

(c) While, in the embodiment, the projection 23 is described as being formed at the molded part 9 which corresponds to the front upper corner of the rear door 3 where the vertical side portion on the pivoted side and the upper side portion thereof intersect with each other, instead of or in addition to this, the projection 23 may be constructed so as to be formed at a molded part which corresponds to a front lower corner portion of the rear door 3 where the vertical side portion on the pivoted side and a lower side portion thereof intersect with each other.

(d) While, in the embodiment, the projection 23 is formed along the whole area of the molded part 9 in the longitudinal direction thereof, the invention is not limited thereto, a construction may be adopted in which at least a projection is provided in such a manner as to have a predetermined length relative to the longitudinal direction of the molded part 9. Of course, this construction includes a construction in which the projection is omitted at a predetermined segment of the molded part 9 in the longitudinal direction thereof to thereby result in a construction in which a plurality of projections are provided in an intermittent fashion.

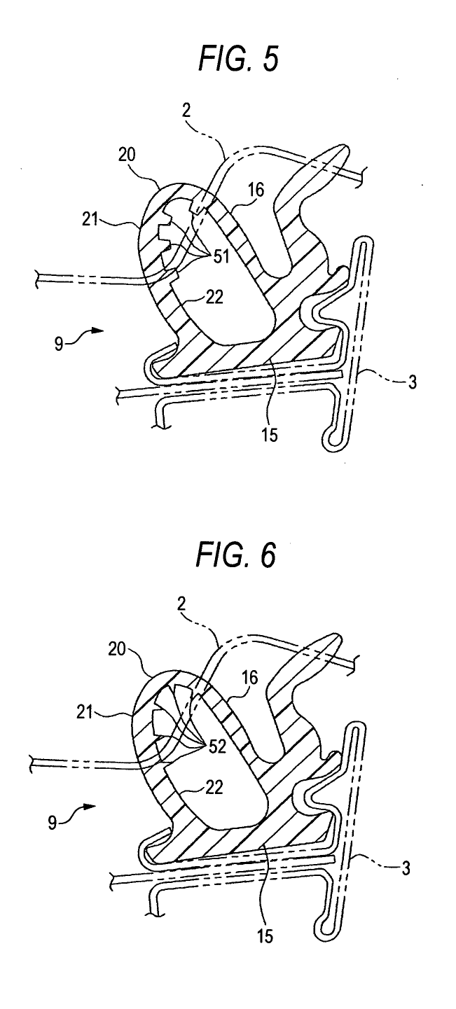

(e) In place of the projection 23 in the embodiment, as shown in FIGS. 5, 6, a construction may be adopted in which at least a rib 51, 52 as an elongated projection is provided on an interior wall surface 22 of a location which corresponds to a seal surface 21 in such a manner as to project from the interior wall surface 22 and to have a predetermined length relative to the longitudinal direction of a molded part 9. Of course, the rib 51, 52 may be provided over substantially the whole area of the molded part 9 in the longitudinal direction thereof. Note that, in the molded parts 9 shown in FIGS. 5, 6, respectively, a plurality of ribs 51, 52 are provided in parallel in a circumferential direction of the interior wall surface 22 of a hollow seal portion 16 which intersects substantially at right angles with a longitudinal direction of the hollow sea portion 16 at a predetermined segment which includes within a range thereof a portion corresponding to a top portion 20 of the hollow seal portion 16. By adopting the construction, similarly to the aforesaid embodiment, the deviation of the position where the twist and creases are generated can be allowed which occurs in the direction which intersects substantially at right angles with the longitudinal direction of the door weather strip 5 due to the manufacturing tolerance and attaching tolerance of the door weather strip 5 and furthermore, a deviation of the contact position between the hollow seal portion 16 and the vehicle body 2, and the effect of suppressing the generation of twist and creases can be increased further, whereby the sealing propertied are increased further.

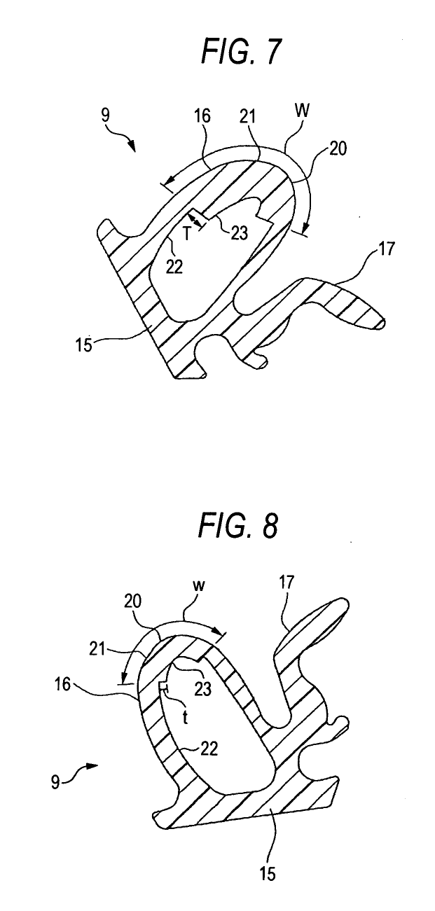

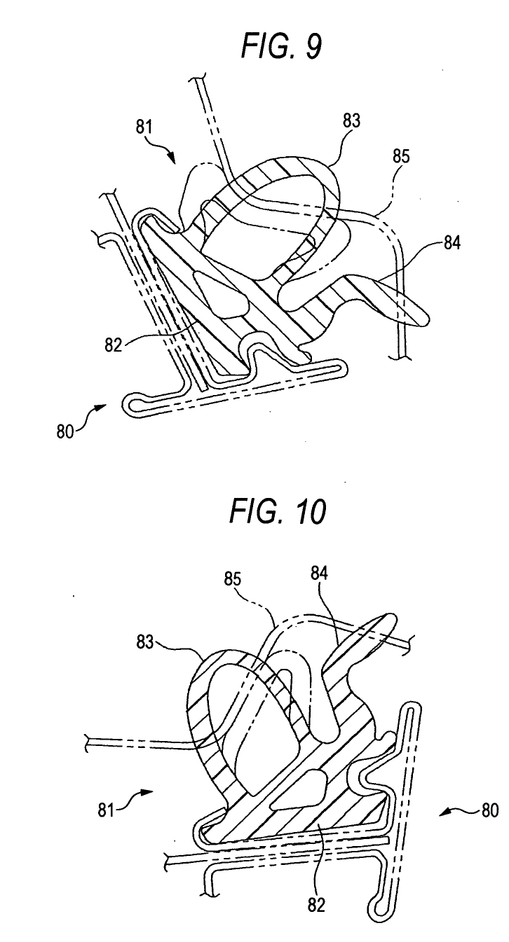

In the aforesaid embodiment, the sectional shape of the projection 23 is made substantially constant over substantially the whole area of the molded part 9 in the longitudinal direction thereof. Namely, in the respective locations, the width of the projection 23 remains substantially constant which width extends in the circumferential direction of the interior wall surface 22 of the hollow seal portion 16 which intersects substantially at right angles with the longitudinal direction of the hollow seal portion 16, and the projecting length of the projection 23 from the interior wall surface 22 is also substantially constant. However, the invention is not limited thereto and may be constructed such that the sectional shape of the projection 23 differs at the respective locations. For example, a construction may be adopted in which the width of the projection 23 which extends in the circumferential direction of the interior wall surface 22 of the hollow seal portion 16 is gradually changed along the longitudinal direction of the hollow seal portion 16 of the molded part 9. In place of or in addition to this, a construction may be adopted in which the projecting length of the projection 23 from the interior wall surface 22 of the hollow seal portion 16 is gradually changed along the longitudinal direction of the hollow seal portion 16 of the molded part 9. As an example of such a form, a construction can be adopted in which the width and projecting length of the projection 23 are gradually changed over substantially the whole area o the molded part 9 in the longitudinal direction thereof, and as shown in FIG. 7, the width of the projection becomes relatively wide and the projecting length thereof becomes relatively long in the vicinity of an end portion of the vertical side portion where the sealing form is made up of the compression type (refer to the line VII-VII in FIG. 2), whereas as shown in FIG. 8, the width of the projection 23 becomes relatively narrow and the projecting length thereof becomes relatively short in the vicinity of an end portion of the upper side portion where the sealing form is made up of the bending type (refer to the line VIII-VIII in FIG. 2).

1. A door weather strip in which a hollow seal portion is attached to a peripheral portion of a vehicle door so as to be brought into contact with a part of a vehicle body when said vehicle door is closed such that a sealing between said vehicle body and said vehicle door is provided, said door weather strip comprising:
a first extruded part disposed along a first side portion of said door;
a second extruded part disposed along a second side portion of said door; and
a molded part molded to connect said first extruded part and said second extruded part in a corner portion where said first side portion and said second side portion of said door meet each other and in a vicinity of said corner portion,
wherein a thickness of at least part of a location of the hollow seal portion in said molded part corresponding to a seal surface which is brought into contact with said vehicle body is made thicker than a thickness of another location of said hollow seal portion.

2. A door weather strip according to claim 1, wherein said first side portion is located on a pivoted side of said door, and the hollow seal portion of said first side portion is brought into contact with said vehicle body in a first sealing form, and the hollow seal portion of said second side portion is brought into contact with said vehicle body in a second sealing form; and
wherein the hollow seal portion in a first portion of said molded part which is disposed along said first side portion is brought into contact with said vehicle body in said first sealing form, and the hollow seal portion in a second portion of said molded part which is disposed along said second side portion of said door is brought into contact with said vehicle body in said second sealing form.

3. A door weather strip according to claim 1, wherein at least a projection is projected on an interior wall surface of a location of the hollow seal portion in said molded part which corresponds to said seal surface and to have a predetermined length relative to a longitudinal direction of said molded part.

4. A door weather strip according to claim 3, wherein said projection is provided over substantially the whole area of said molded part in the longitudinal direction thereof.

5. A door weather strip according to claim 3, wherein said projection is provided along a circumferential direction of said interior wall surface of the hollow seal portion which intersects substantially at a right angle with a longitudinal direction of said hollow seal portion in a predetermined width so as to include a portion corresponding to a top portion of said hollow seal portion within a range thereof.

6. A door weather strip according to claim 5, wherein the width of said projection which extends along the circumferential direction of said interior wall surface of said hollow seal portion is gradually changed along the longitudinal direction of said hollow seal portion of said molded part.

7. A door weather strip according to claim 3, wherein a projecting length of said projection from said interior wall surface of said hollow seal portion is gradually changed in the longitudinal direction of said hollow seal portion of said molded part.

8. A door weather strip in which a hollow seal portion is attached to a peripheral portion of a vehicle door so as to be brought into contact with a part of a vehicle body when said door is closed, such that a sealing between said vehicle body and said vehicle door is provided, said weather strip comprising:
a first extruded part disposed along a first side portion of said door;
a second extruded part disposed along a second side portion of said door; and
a molded part molded to connect said first extruded part and said second extruded part in a corner portion where said first side portion and said second side portion of said door meet each other and in a vicinity of said corner portion,
wherein at least an elongated projection is projected on an interior wall surface of at least a location of the hollow seal portion in said molded part which corresponds to a seal surface which is brought into contact with said vehicle body and to have a predetermined length relative to a longitudinal direction of said molded part.

9. A door weather strip according to claim 8, wherein said first side portion is located on a pivoted side of said door, and the hollow seal portion of said first side portion is brought into contact with said vehicle body in a first sealing form, and the hollow seal portion of said second side portion is brought into contact with said vehicle body in a second sealing form; and
wherein the hollow seal portion in a first portion of said molded part which is disposed along said first side portion is brought into contact with said vehicle body in said first sealing form, and said hollow seal portion in a second portion of said molded part which is disposed along said second side portion of said door is brought into contact with said vehicle body in said second sealing form.

10. A door weather strip according to claim 8, wherein said elongated projection is provided over substantially the whole area of said molded part in the longitudinal direction thereof.

11. A door weather strip according to claim 8, wherein a plurality of said elongated projections are provided in parallel in a predetermined segment extending along a circumferential direction of said interior wall surface of said hollow seal portion which intersects substantially at a right angle with a longitudinal direction of the hollow seal portion which segment includes within a range thereof a portion corresponding to a top portion of said hollow seal portion.

12. A door weather strip according to claim 8, wherein the width of said elongated projection which extends along a circumferential direction of said interior wall surface of said hollow seal portion is gradually changed along the longitudinal direction of said hollow seal portion of said molded part.

13. A door weather strip according to claim 8, wherein a projecting length of said elongated projection from said interior wall surface of said hollow seal portion is gradually changed in the longitudinal direction of said hollow seal portion of said molded part.
